(19) United States
(12) Patent Application Publication
(10) Pub. No.: US 2011/0289017 A1
(43) Pub. Date: Nov. 24, 2011

(54) Systems and Methods for Asynchronous Risk Model Return Portfolios

(75) Inventor: Anthony Renshaw, New York, NY (US)

(73) Assignee: Axioma, Inc., New York, NY (US)

(21) Appl. No.: 12/827,358

(22) Filed: Jun. 30, 2010

Related U.S. Application Data
(60) Provisional application No. 61/346,308, filed on May 19, 2010.

(51) Int. Cl. G06Q 40/00

(52) U.S. Cl. 705/36 R

(57) ABSTRACT

Portfolio optimization typically involves a risk model to control the level of risk in the portfolio constructed. By creating different portfolios using different risk models (fundamental or statistical; long, medium or short horizon) corresponding to different times or dates (a current or an old risk model), one obtains a large number of low risk (volatility) portfolios. A risk model return portfolio is the difference in the any two of these portfolios, and a risk model return is the return associated with a risk model return portfolio. A number of risk model return portfolios exhibit repeatable returns that can be used to an investor's advantage. Furthermore, these returns exhibit very low correlation with the benchmark returns. As such, they are uncorrelated sources of return. Such returns are considered valuable by investors. The present invention uses risk model return portfolios and their returns to create attractive investments for investors. The risk model return portfolios can be used to analyze market trends and create implied alphas for portfolio construction. They can also be used to provide constituent information that can be further used as the basis for an exchange traded fund (ETF), index or other investment vehicle.

The present application claims the benefit of U.S. Provisional Application Ser. No. 61/346,308 filed May 19, 2010 which is incorporated by reference herein in its entirety.

### FIELD OF INVENTION

The present invention relates generally to improved quantitative tools for investing. More particularly, it relates to improved computer-based systems, methods and software for improved modeling and managing of investments, particularly equity investments. The invention includes what is termed a risk model return portfolio, which is the difference of two portfolios, where risk models corresponding to different times are used to define and create two distinct portfolios. One common application is where the risk models are equity factor risk models. The present invention relates to tools for: (1) computing risk model return portfolios; and (2) methods and tools for using risk model return portfolios for improving investment processes.

### BACKGROUND OF THE INVENTION

There are several well known mathematical modeling techniques for estimating the risk of a portfolio of financial assets such as securities and for deciding how to strategically invest a fixed amount of wealth given a large number of financial assets in which to potentially invest.

For example, mutual funds often estimate the active risk associated with a managed portfolio of securities, where the active risk is the risk associated with portfolio allocations that differ from a benchmark portfolio. Often, a mutual fund manager is given a “risk budget”, which defines the maximum allowable active risk that he or she can accept when constructing a managed portfolio. Active risk is also sometimes called portfolio tracking error. Portfolio managers may also use numerical estimates of risk as a component of performance contribution, performance attribution, or return attribution, as well as, other ex-ante and ex-post portfolio analyses. See for example, R. Litterman, Modern Investment Management: An Equilibrium Approach, John Wiley and Sons, Inc., Hoboken, N.J., 2003 (Litterman), which gives detailed descriptions of how these analyses make use of numerical estimates of risk and which is incorporated by reference herein in its entirety.

Another use of numerically estimated risk is for optimal portfolio construction. One example of this is mean-variance portfolio optimization as described by H. Markowitz, “Portfolio Selection”, Journal of Finance 7(1), pp. 77-91, 1952 which is incorporated by reference herein in its entirety. In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions, Sharpe ratio, value-at-risk, robust optimization, and optimization including Axioma's Alpha Factor methodology. See U.S. Pat. No. 7,698,202 which is incorporated by reference herein in its entirety.

In the absence of forecasted expected returns, portfolio optimization can be used to create low risk portfolios; that is, portfolios that have low total or active risk. The portfolio optimization may also include constraints on asset holding and exposures to industries, sectors, countries or currencies. For example, U.S. Published Patent Application 2003/0233302, which is incorporated by reference herein in its entirety, describes the use of multifactor risk models to construct a hedging portfolio to an actively managed traded fund. One method for constructing such a hedging portfolio would be to use an optimizer.

Mutual funds and exchange traded funds (ETFs) are baskets of securities with particular characteristics. An ETF is an investing tool that is similar to stocks, except that the shares of a given ETF represent an index of stocks, other securities or other investments rather than a single company stock. Similar to mutual funds, ETFs provide an investor with various types of diversity within a single fund. However, ETFs provide the added benefit of lower expenses, greater transparency, better tax efficiency, and flexibility. Examples of ETFs are the Standard & Poor's Depository Receipt (SPDR), otherwise known as spider, that trades as a stock on the American Stock Exchange and is an index of, or otherwise represents, the S & P 500; Diamonds (DIA) that trades as a stock on the American Stock Exchange and is an index of, or otherwise represents, the thirty stocks in the Dow Jones Industrial Average; Cubes (QQQQ) trades as a stock on the NASDAQ and is an index of, or otherwise represents, the NASDAQ 100.

According to Thomson Financial Services, there are hundreds of ETFs, both indexed and closed-end funds, currently available in the marketplace. Each of these ETFs represents a diversified mix of shares which themselves are unique products in the public markets. Often an ETF invests in one specific type or specialized sector of a given industry or market. The ETF of the invention could likewise comprise the top percentage of ETFs in a specific industry or market or could, in contrast, comprise ETFs from diverse industries or markets.

For decades, factors based on principles of financial accounting have been used in multifactor models of asset returns. The use of financial ratios and other metrics to capture the profitability, market valuation, degree of financial leverage and operational efficiency of firms has a long history in portfolio management and returns attribution, dating as far back as Graham and Dodd's 1934 classic, “Security Analysis” (McGraw-Hill, 1934), which is incorporated by reference herein in its entirety.

A central idea surrounding factor based investing is the notion of a factor return. There are several different methods for defining factor returns. A particularly simple method is to pick a factor, such as value (which could be a price-to-book value ratio or a price to earnings ratio) or momentum (a recent historical return of an asset), and assign each asset in the investible universe a score for that factor. The factor return is then created by creating two portfolios. One portfolio is a subset of the investible universe with high scores. This portfolio could be created using a number of techniques. It could weight each asset by its market capitalization (“cap-weighting”) or it could give each asset equal weight (“equi-weighting” or “equal weighting”). It could be the top 20% of the investible universe or the top 35%. The second portfolio is constructed by creating an analogous portfolio of assets with low factor scores. The factor return is then the difference in the returns of these two portfolios, and the factor portfolio is the difference of these two portfolios.

There are, to be sure, other ways of defining factor returns. For example, in factor risk models, a cross-sectional, multi-dimensional regression is often performed modeling the returns (daily, weekly, or monthly) of a chosen universe of assets across a set of strategically chosen factors, each of which has been assigned a factor exposure. The factor returns are the coefficients returned by the regression analysis. See for example, R. C. Grinold, and R. N. Kahn, Active Portfolio Management: A Quantitative Approach for Providing Superior Returns and Controlling Risk, Second Edition, McGraw-Hill, New York, 2000, which is incorporated by reference herein it its entirety, and Litterman.

Factor returns have been used for decades to make investment decisions and as inputs to factor risk models. Factors play a key role in investment decisions. For example, most mutual funds, index funds, and ETFs are now commonly assigned into categories depending on whether the fund is made up of large cap, medium cap or small cap stocks or the like. In this case, size is taken as a factor. Mutual funds and ETFs can also be designed so that they reflect the characteristics of well known factors. For example, industry specific ETFs exhibit the characteristics of a particular industry, and industries are a commonly used and studied factor that also frequently is used in fundamental-factor risk models. While not analogous, there are nevertheless substantial interconnections between factors, risk model predictions, and portfolios such as ETFs.

Existing tools and methods for assisting people in investments are numerous. However, most of the factors commonly used by investors have been described and used for decades. See Graham and Dodd, Grinold and Kahn, and Litterman for general surveys.

### SUMMARY OF THE INVENTION

Among its several aspects, the present invention recognizes the following defects and disadvantages with these existing tools and factors:
Most factors have been studied extensively. As such, new insights into the potential performance of these factors are limited.
In general, existing factors are generally not defined using the output of a risk model. The existing factors are commonly used as inputs to risk models. However, the output of risk models is generally not used as separate asset specific metrics. To be sure, certain metrics such as marginal contribution to risk or active risk give metrics at the asset level. But, in general, few factors are defined by the output of a risk model calculation. Therefore, all the information contained within the risk model is not advantageously used for defining potentially valuable factors.

Among its several aspects, the present invention also recognizes a need for new, useful metrics for capturing market trends and providing quantitative measures for making investment decisions. This goes almost without saying: any new factors that provide insight into potentially profitable investments will be highly valued. However, in today's investment world, investors have access to a large amount of information. The number of potential metrics that could be constructed by combining various pieces of data together through mathematical formulas is far larger than can ever be practically computed. It is not a lack of data that makes new and useful factors hard to find.

Therefore, there is a need for new and useful metrics such as factors for analyzing trends, capturing market characteristics, and modeling and predicting future investment returns.

There is also a need for these metrics to be easily understood, as well as, substantially different than other well known factors.

Therefore, there is a need for a new and useful way to use risk models to produce information than can be advantageously used to make investment decisions.

A convenient platform for analyzing and using new and useful metrics would be a web-based tool accessible from the Internet. Such a tool would be inexpensive to access, and can provide the kind of input and user feedback required. Another platform would be a stand-alone software program that could be run on a computer. The tool could also run on a computer server, which would allow remote access to one or more users. The tool could also be run on a small portable device such as an IPad™, IPod™, IPhone™ or BlackBerry™.

Among its several aspects, the present invention provides a method for computing an investment return portfolio from the output of two optimizations using at least two risk models corresponding to different times or dates. The date or time corresponding to a risk model is a measure of the most recent market information used to construct the risk model. In other words, the risk model time gives an indication of what time the risk model predictions are expected to be most accurate. Typically, a portfolio construction optimization problem is set up to create a portfolio using a single risk model. A risk model return portfolio is the portfolio associated the differences in the portfolios generated by two differently timed risk models. A risk model return is the return of that portfolio.

The risk models can be fundamental factor risk models, statistical factor risk models, or dense covariance risk models. They could correspond to short, medium, and long-horizon risk predictions.

A number of risk model return portfolios exhibit repeatable returns that can be used to an investor's advantage. Furthermore, the returns of these portfolios exhibit very low correlation with the benchmark returns or the returns associated with a cap-weighted portfolio of all stocks in the investible universe. As such, they are uncorrelated sources of return. Such returns are often called alphas (see Litterman) and are considered valuable by investors. The present invention uses risk model return portfolios to create attractive investments for investors as discussed in further detail below.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 illustrates how N is defined, where N is the number of trading days from the last trading day of the month;

FIGS. 3A and 3B illustrate the cumulative return of the monthly risk model return portfolios for first and second examples;

FIG. 4 illustrates the cumulative return of the monthly risk model return portfolios extended back to 1995 for the first example;

FIG. 5 illustrates the cumulative return of the monthly risk model return portfolios extended back to 1995 for the inverse of the second example;

FIG. 6 shows a plot of 125-day rolling betas, illustrating the correlation of the first example returns with the Russell 1000 returns;

FIG. 7 shows a plot of 125-day rolling betas illustrating the correlation of the inverted second example returns with the Russell 1000 returns;

FIG. 8 illustrates 60-day realized risk (in percent annual volatility) for the first example (lower) and the Russell 1000 benchmark (upper);

FIG. 9 illustrates 60-day realized risk (in percent annual volatility) of the inverted second example (lower) and the Russell 1000 (upper);

FIG. 10 illustrates cumulative returns for the first example using different values for NRebal; and

FIG. 11 illustrates cumulative returns for the inverted second example using different values for NRebal.

### DETAILED DESCRIPTION

The present invention may be suitably implemented as a computer-based system, in computer software which is stored in a non-transitory manner and which may suitably reside on computer readable media, such as solid state storage devices, such as RAM, ROM, or the like, magnetic storage devices such as a hard disk or floppy disk media, optical storage devices, such as CD-ROM or the like, or as methods implemented by such systems and software.

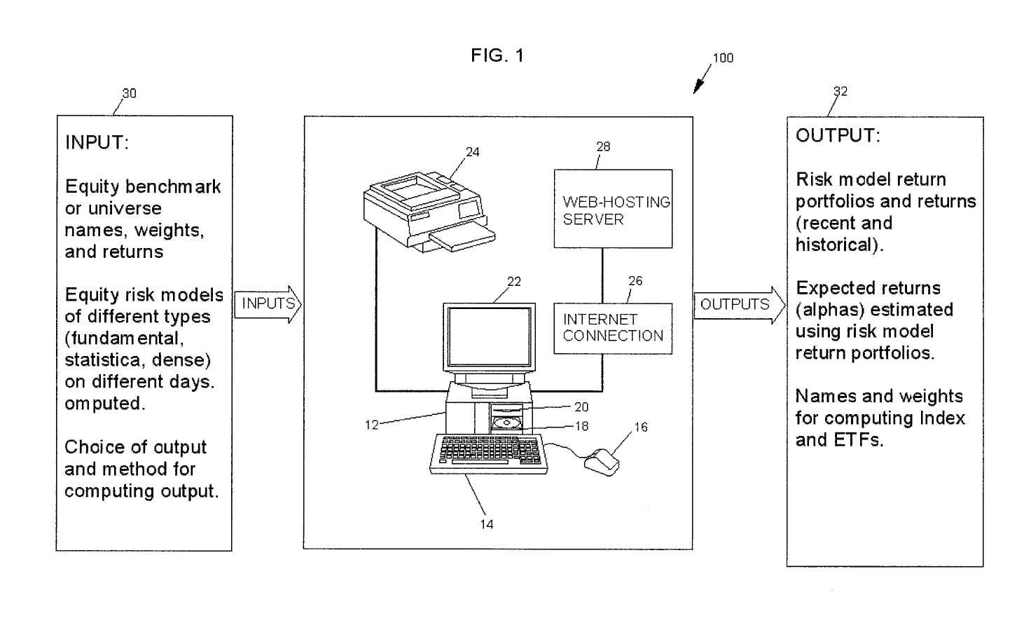

FIG. 1 shows a block diagram of a computer system 100 which may be suitably used to implement the present invention. System 100 is implemented as a computer 12 including one or more programmed processors, such as a personal computer, workstation, or server. One likely scenario is that the system of the invention will be implemented as a personal computer or workstation which connects to a server 28 or other computer through an Internet connection 26. In this embodiment, both the computer 12 and server 28 run software that when executed enables the user to input instructions and calculations on the computer 12, send the input for conversion to output at the server 28, and then displays the output on a display, such as display 22, or is printed out, using a printer, such as printer 24, connected to the computer 12. The output could also be sent electronically through the Internet connection 26. The computer would only need an Internet browser program such as Internet Explorer or Mozilla Firefox or Google Chrome to use the present invention. In another embodiment of the invention, the entire software is installed and runs on the computer 12, and the Internet connection 26 and server 28 are not needed. In still a further embodiment, the Internet connection is replaced with a local area network. As shown in FIG. 1 and described in further detail below, the system 100 includes software that is run by the central processing unit of the computer 12. The computer 12 may suitably include a number of standard input and output devices, including a keyboard 14, a mouse 16, CD-ROM drive 18, disk drive 20, monitor 22, and printer 24. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as an IPad, IPhone, IPod, Blackberry™, Treo™, or the like.

One embodiment of the invention has been designed for use on a stand-alone personal computer running in Windows (Microsoft XP, Vista, 7).

According to one aspect of the invention, it is contemplated that the computer 12 will be operated by a user in an office, business, trading floor, classroom, or home setting.

As illustrated in FIG. 1, and as described in greater detail below, the inputs 30 may suitably include equity benchmark names for a selection universe stored in memory, weights, and returns; equity risk models of different types (fundamental, statistical, or dense) corresponding to different historical times and dates; and a selection of the methods or algorithms for computing risk model return portfolios.

As further illustrated in FIG. 1, and as described in greater detail below, the system outputs 32 may suitably include risk model return portfolios (recent and historical) and their returns; expected returns (alphas) estimated using recent and historical risk model return portfolios; and the names and weights of attractive investment portfolios that could be used for constructing indexes or ETFs (exchange traded funds) that would replicate or capture the return performance of the risk model return portfolios.

The output information may appear on a display screen of the monitor 22 or may also be printed out at the printer 24. The output information may also be electronically sent to an intermediary for interpretation. Other devices and techniques may be used to provide outputs, as desired.

With this background in mind, we turn to a detailed discussion of a presently preferred embodiment of the invention and its context beginning with a description of the invention with reference to a particular example.

In recent years, a number of observers have claimed that market returns have been driven by the fact that many investors have similar investment strategies. For example, many hedge funds are believed to invest in assets that have a strong tilt towards both medium-term momentum (i.e., asset returns over the last year minus the most recent month) and value (e.g., high book to price ratio). Historically, such tilts have generally had strong performance—that is, positive returns.

A problem with many people having very similar bets is that, when the market becomes volatile and the performance of those bets turns against the investors, many investors attempt to execute the same kinds of trades to reduce their exposure to the underperforming assets. When many people attempt to trade a similar subset of assets in the same direction (typically all selling), the market moves against these sellers, driving the price of those assets even lower resulting in more selling, and so on. This market movement creates a cycle of trading that works against many investors. One term for this effect that has been coined is “crowded trading”. Another is a “herd mentality”.

The invention also takes note that many events in the equity market often occur at a regular pattern with respect to the end of the month and addresses such events as addressed further below. For example, benchmarks and indexes are often reconstituted at the end of the month. Companies often reveal financial and accounting information in reports that are released near the end of the month. Another monthly event involves the release of risk models, including equity, fixed income, and the like. For example, Barra, an industry leader in equity factor risk models, releases its US equity risk model on a monthly basis. Each month's risk model is updated a few days after the end of the month. While the exposures of different equities may be updated more frequently, the factor-factor covariance in Barra's risk models is updated only once a month. For portfolio managers relying on these risk models to help determine trades, it is easy to believe that the monthly release of these risk models may cause different portfolio managers to make similar trades at the same time soon after the risk model release.

Another phenomenon that occurs monthly is that hedge funds and mutual funds often receive cash inflows and distribute cash to investors at monthly intervals. Portfolios managers with a large inflow of cash at the end of the month must invest that relatively quickly to satisfy mandates of the fund. In addition, portfolio managers often report performance on a monthly basis. This provides a final layer of information to investors all of which is synchronized with the reporting cycle, which is often synchronized with the end of the month.

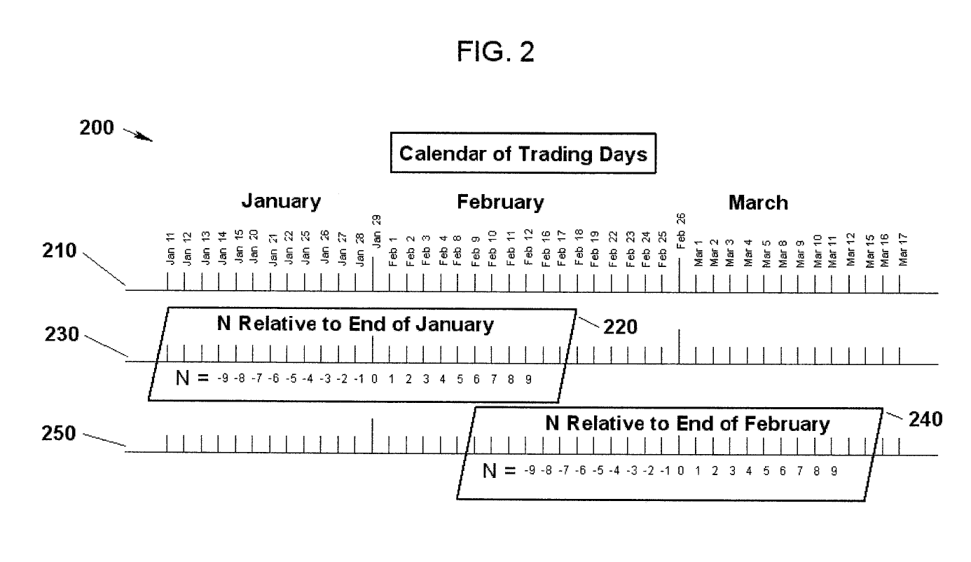

To address such events, the present invention introduces a variable N that defines the number of days before or after the end of the month. Thus, N=0 refers the to market close on the last trading day of the month. N=+1 means the next trading day. N=−1 refers to the day before the last trading day of the month and so on. This notation is illustrated in FIG. 2 which provides a trading day calendar 200 illustrating how N would be defined for the end of January and, simultaneously for the end of February. Notice that the first line 210 in the chart lists the trading days for January, February, and March. This trading day calendar skips weekends and holidays (for example, Martin Luther King Day, celebrated on a Monday when the stock market is closed, a non-trading day). The box 220 on the second line 230 shows how N would be defined relative to the last trading day of January, January 29. January 29 is N=0; February 1 is N=+1, February 2 is N=+2; etc. January 28 is N=−1; etc. The box 240 on the third line 250 illustrates how N is defined relative to the last trading day of February. February 26 is N=0; March 1 is N=+1 and February 25 is N=−1. Notice that these two sets of definitions for N overlap. February 12 is both N=+9 relative to the end of February, and N=−9 relative to the end of March.

Since most months have between 19 and 21 trading days, there is overlap between these numbers. However, the overlap is imperfect, since the number of trading days is not the same from one month to the next. Often, when using N, we will restrict ourselves to N values from minus ten to plus ten in order to refer to a set of most common values without substantial overlap. We often may report results for N varying between minus five and plus five, to further eliminate potential overlap. We could also restrict ourselves to N from zero to twenty if that proved more useful or convenient.

Knowing all that goes on in the market and how it is often synchronized with the end of the month, one could formulate the following hypothesis: When Barra releases its risk model during the first few days of the month (N=2 to 5, say), many portfolio managers will trade into positions that are defined as low risk positions by this updated model. They will simultaneously sell out of positions that either previously were low risk (e.g., last month's Barra model) or that are defined as low risk using modeling that is different than Barra's (e.g., they may miss or overlook names that are deemed low risk by a statistical factor risk model that are not as low risk when modeled using Barra's risk model, which is a fundamental factor risk model).

Note that some risk model providers such as Axioma produce risk models for every trading day. All components of these risk models are updated daily including the factor-factor covariance, specific risk, and exposures, using the most recent, up-to-date market information. With such a vendor, it is possible to use different current and old risk models corresponding to different trading dates for various computational purposes.

Other risk model providers compute intra-day risk estimates that change dynamically through each trading day. With these kinds of risk models, it is possible to use risk models corresponding to different times on the same trading day, or, alternatively, risk models from different dates that may or may not correspond to different times during the day.

As a first example, suppose a portfolio manager is planning on trading on the opening of the fifth trading day of the month using information as of the close of fourth trading day of the month. That is, the portfolio manager uses and trades based on N=+4 information. Furthermore, he does this every month. He uses a Barra risk model, which is correct as of the end of January. This risk model is already four days old by the time the portfolio manager submits his trades. He suspects that many people have been and will trade into names that are low risk as defined by an up to date fundamental risk model. That is, people will have already started trading using either Barra's model or a different model that substantially replicates Barra's model, and those equities with low risk based on that model are doing especially well in the first few days of the month. He suspects that assets that are deemed low risk by an older, statistical factor risk may not be doing as well as most portfolio managers will think they have high risk.

Using this hypothesis, he constructs two different portfolios. In portfolio one, he creates a portfolio of at most one hundred names that has the minimum tracking error to the Russell 1000 benchmark, a well known benchmark of large cap assets. In this example, the equities in the Russell 1000 benchmark for N=+4 comprise a first selection universe of names of possible investment holdings. The portfolio construction problem here is to construct a portfolio with at most one hundred names and minimum tracking error. This is, of course, just one example of a possible portfolio construction problem that may or may not involve portfolio optimization. When doing this construction, he uses a fundamental factor risk model that is current—that is, one that is dated as of N=+4.

For portfolio number two, he creates a portfolio of at most one hundred names that has minimum tracking error to the Russell 1000 using a statistical factor risk model that is dated as of N=+1; that is, a model that is three days old, utilizes most of the same market information that went into Barra's monthly risk model update, but measures and reports risk using statistical factors rather than fundamental factors. In this example, the equities in the Russell 1000 benchmark for N=+1 comprise a second selection universe of names of possible investment holdings.

These two portfolios are likely to be similar. They will hold many of the same names, and will have similar weights. They will not, however, be identical portfolios. The small differences in the names and weights will represent a quantitative measure of a trend in the market that the portfolio manager wishes to exploit. Therefore, it is the changes in positions and weights of these two portfolios measured from N=+4 in one month to N=+4 in the next month that is of most interest to the portfolio manager. For simplicity, the portfolio manager may create a risk model return portfolio by subtracting the two portfolios.

The return of this risk model return portfolio is the difference in returns of two portfolios defined by creating low risk portfolios using risk models of possibly different types and different days is defined herein as a risk model return. It is analogous to a classic factor return defined as the difference in two portfolios, one with a high factor score and one with a low factor score, but significantly different in that the two portfolios that are compared are not defined by high and low factor scores but rather by separate portfolio optimizations using risk models associated with different times, as addressed further below.

The first thing the portfolio manager wishes to do is determine how well the return of this particular risk model return portfolio has performed historically.

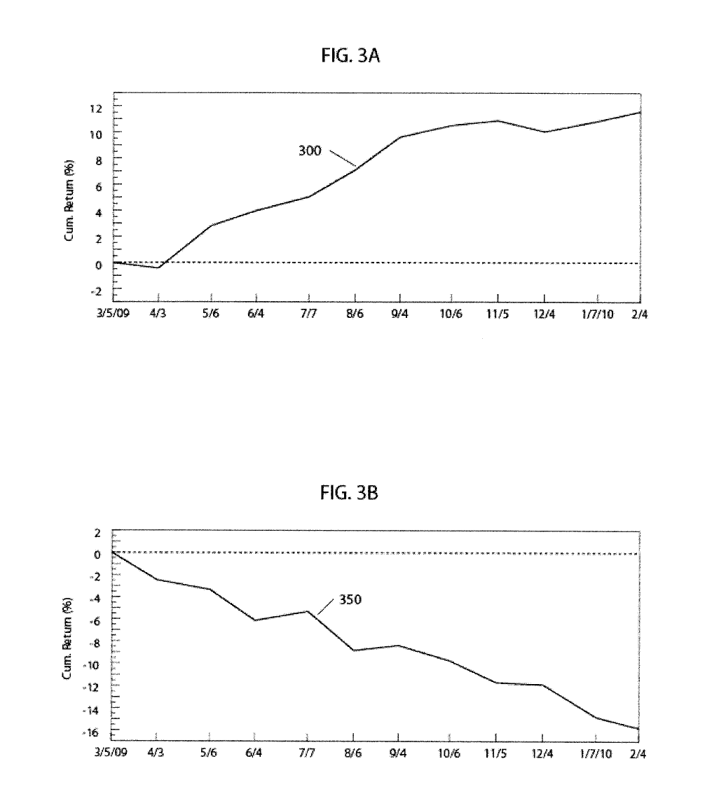

FIG. 3 shows a graph of the cumulative return 300 of this set of risk model return portfolio returns over eight months from Mar. 5, 2009 to Feb. 3, 2010. The return is approximately 11.5% and has been positive for most of these months. This information encourages the portfolio manager, so he intends to place a bet on February 4 (traded on February 5^{th}) that will capture this return.

There are many ways to replicate or capture the performance of this particular risk model return portfolio. One method would be to invest in a long/short dollar neutral portfolio that comprises the difference in portfolios one and two. Such a portfolio will exactly replicate the risk model return portfolio return described here.

A second method, which does not necessarily involve shorting assets, would be to compute the implied alpha of the long/short dollar neutral portfolio using a third risk model. This computation is a standard calculation that produces the expected returns that would have lead to the initial set of holdings for an unconstrained mean-variance optimization problem. In this example, there are both fundamental and statistical risk models explicitly used on various dates that could be used as the third risk model. There is also the possibility of other risk models such as a dense risk model that could be used. The portfolio manager could also average risk models or implied alphas to come up with different potential implied alphas. The portfolio manager therefore has many implied alphas that he could compute. Suppose, for instance, that he computes the implied alphas using the most up-to-date fundamental risk model. With this implied alpha information, he could then construct a portfolio that maximizes the net exposure to the implied alpha using any additional investment constraints that he feels are important. Alternatively, one could limit the exposure of an optimized portfolio to the positive, negative, or zero implied alphas.

Note that this second approach enables portfolio managers to incorporate the investment information of a specific risk model return portfolio into an existing investment decision making process very easily. This gives the portfolio manager great flexibility to use the most up to date information without changing his established investment process.

There are, of course, many other ways in which this particular risk model return portfolio could be replicated or used in an investment process. These will be apparent based on the discussion herein to those skilled in these arts.

As a second specific example, suppose, as before a portfolio manager is planning on trading on the opening of the fifth trading day of the month using information as of the close of the fourth trading day of the month. He suspects that many people will trade into names that are low risk as defined by an up to date fundamental risk model and trade out of names that used to be low risk last month when portfolio managers used Barra.

Using this hypothesis, he constructs two different portfolios. For portfolio one, he creates a portfolio of at most fifty names that has the minimum tracking error to the Russell 1000 benchmark. When doing this, he uses a fundamental factor risk model that is current—that is, one that is dated as of N=+4. In this example, the equities in the Russell 1000 benchmark for N=+4 comprise a first selection universe of names of possible investment holdings.

For portfolio two, he then creates a portfolio of at most fifty names that has minimum tracking error to the Russell 1000 using a fundamental factor risk model that is old—specifically, one with N=−5. In this example, the equities in the Russell 1000 benchmark for N=−5 comprise a second selection universe of names of possible investment holdings.

As before, these two portfolios are likely to be similar, but the difference in returns of the two portfolios may reveal important information concerning profitable market investments and market trends.

FIG. 3B shows a graph of the cumulative return 350 of this set of risk model return portfolios returns over 8 months from Mar. 5, 2009 to Feb. 4, 2010. The return is steadily negative, losing almost 16% over 8 months. Initially, this may appear to be a poor outcome, but in fact, it is revealing. If we simply change our example so that we use the return of portfolio two minus the return of portfolio one, referred to herein as an inverse example, then a strong positive signal is recorded. Of course, the intuition changes as we reverse the roles of portfolios one and two. It appears that the low risk names in the old fundamental model (portfolio two) outperform those in the up-to-date fundamental model (portfolio one). This appears to be a case of market over-reaction, where portfolio managers are so anxious to get out of old, low risk names, that these actually become good investment opportunities.

While the intuition behind what combinations of low risk portfolios to use in creating risk model return portfolios is subjective, their realized performance is not. By doing historical tests testing various types of risk model return portfolios, insight can be obtained into what combinations work best, and which may represent the best current investment opportunities and market trends.

For example, we can extend the historical results of the first example and the inverse example further back in time to see how well these examples performed.

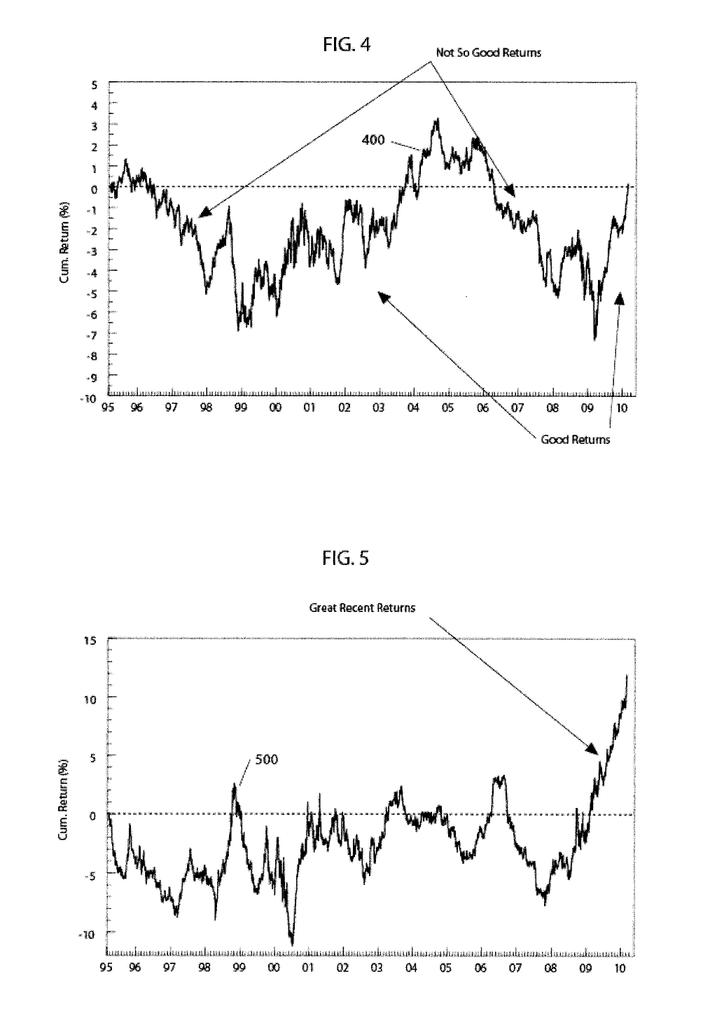

FIG. 4 shows the cumulative return 400 for example one. As indicated in the diagram, the returns of this particular risk model return portfolio fall into four distinct periods. From 1995 through 1999, the returns were generally negative. Then, from 1999 to 2005, the returns were generally positive. From 2005 to 2009, they were generally negative again. Finally, since 2009, they have been generally positive. The stock market experienced two periods of very high volatility, first in 2000 and then in 2008. It appears that this particular example may have strong positive returns whenever market volatility rises. This would match the intuition used to initially generate the example.

FIG. 5 shows the cumulative returns 500 of the inverse example two (that is, portfolio two minus portfolio one, old minus new). This particular strategy has only done well since 2008. Prior to that, it had both positive and negative runs, but overall remained relatively flat. These two figures illustrate that recent performance may not be indicative of older or future performance.

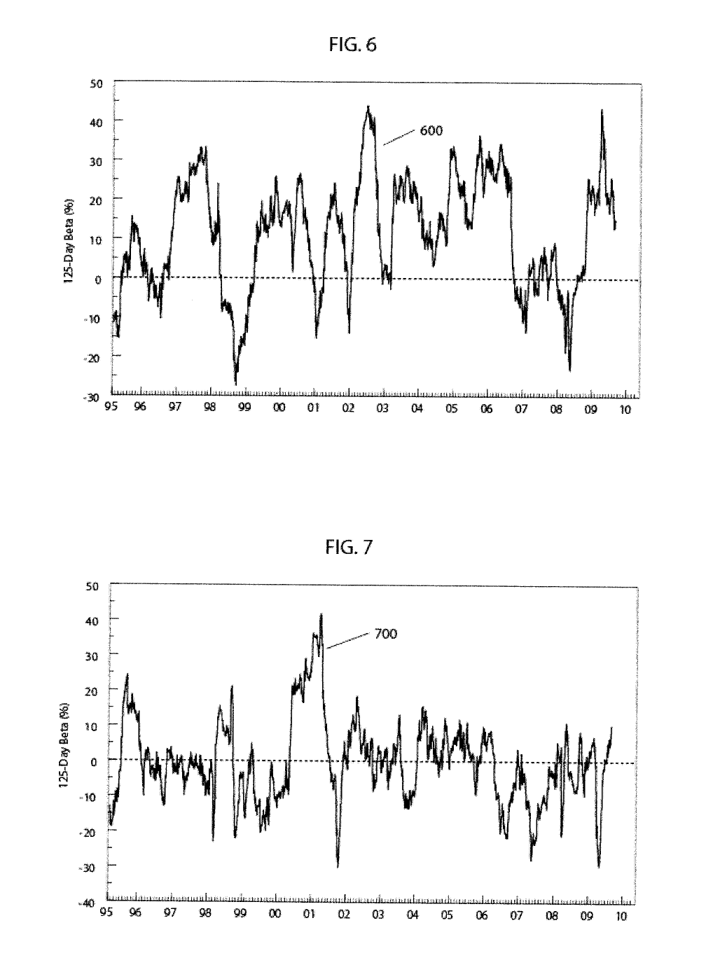

Risk model return portfolios possess additional qualities that make them attractive. First, their returns have low correlation to market returns. FIGS. 6 and 7 show plots of beta 600 and 700, respectively, the correlation of the returns of each example with the returns of the underlying benchmark, which in this case is the Russell 1000 Index. FIG. 6 shows example one. FIG. 7 shows inverted example two. In both cases, the rolling, 125-day correlation is computed. For both cases, the betas are small. They vary over time, with isolated peaks of over 40%, but their absolute magnitude is less than 20% for the vast majority of time. This is the hallmark of true alphas—they are uncorrelated with market returns.

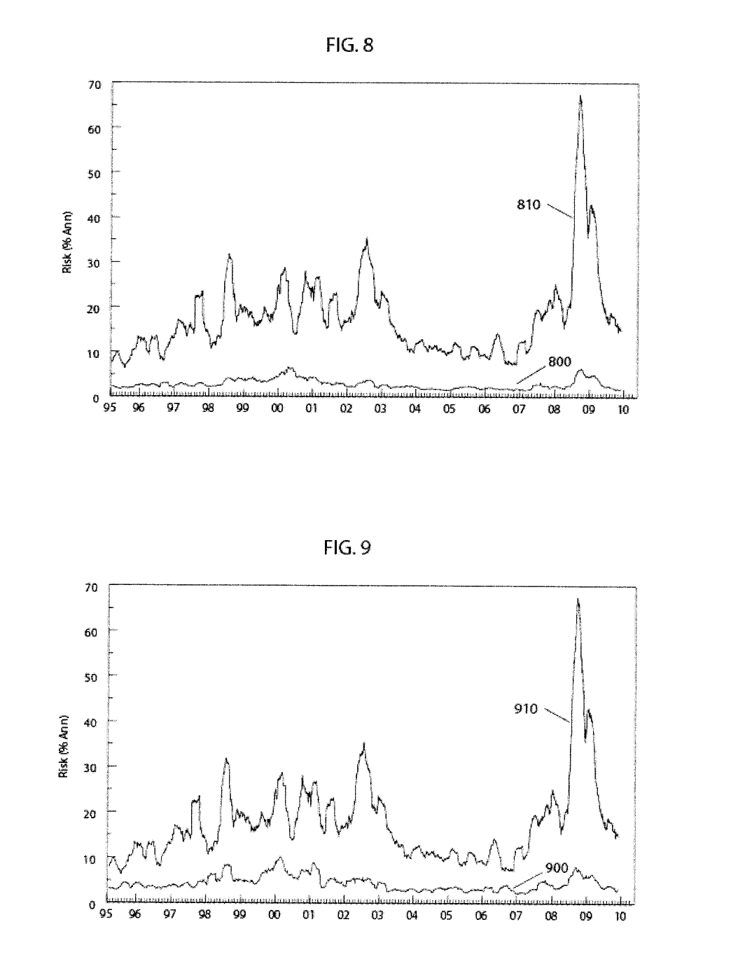

FIGS. 8 and 9 show the realized risks 800/810 and 900/910, respectively (in this case, 60 day forward realized volatility) of both the example 800/900 and the benchmark 810/910. The benchmark realized risk 810 and 910 is the same in both graphs. It is usually between 10% and 20%, but it has peaks, including a large peak of over 65% in late 2008. In contrast, the two examples have very low risk 800 and 900, typically less than 5% annual volatility. They, too, have peaks, but the peaks reach 7% for the first example and 10% for example two. The market returns have very small realized risk, a property that is often attractive to investors.

The two examples described in detail above were for returns measured between N=+4 of one month to N=+4 of the next month. The same kind of risk model return can be done for other rebalance/return N. In doing so, we will keep the relative dates the same; that is, in example one, the old, statistical risk model will be 3 days old, and in example two, the old fundamental risk model will be nine days old, both with respect to N, the rebalance date.

In order to distinguish the different N's used by these different risk model returns, we will use the variable NRebal to denote the date in the month on which rebalancing takes place (i.e., that date from which the monthly returns are measured). NLong will denote the N associated with one portfolio, while NShort will be the other portfolio. The return used will always be that of NLong minus that of NShort.

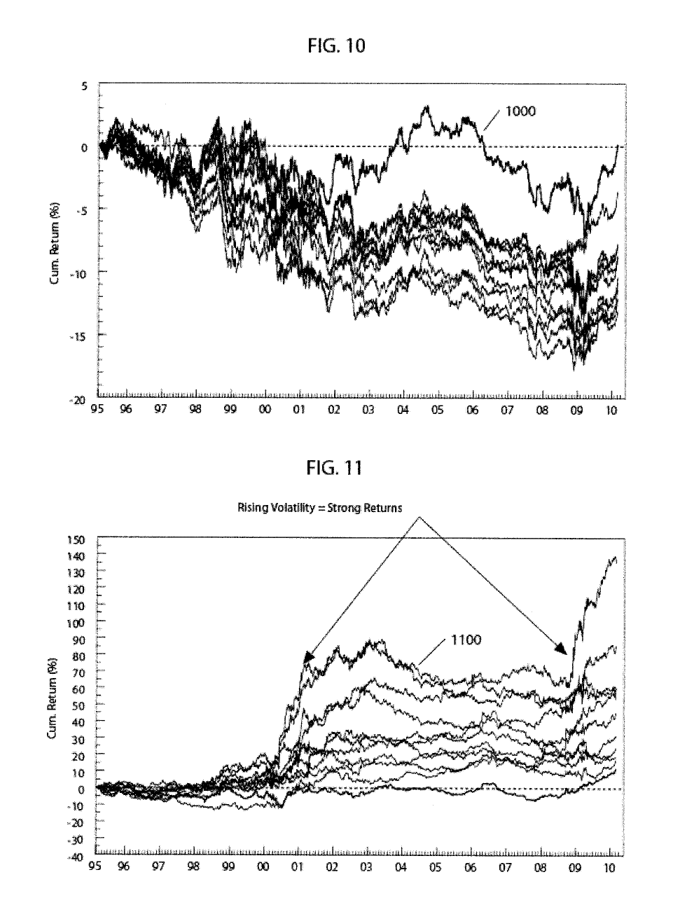

FIGS. 10 and 11 show the cumulative returns 1000 and 1100 for example one and the inverted example two, respectively for NRebal varying from −5 to 5. The original examples, have NRebal=+4. As can be seen in these figures, there is a wide range of different historical risk model return portfolio behavior. Although example one has had positive returns since 2009, for most of its history, the returns have been negative. In fact, only the original NRebal=+4 case remains close to 0% return between 2003 and 2008. Example two, on the other hand, was generally flat except in 2009-2010, where it posted strong positive returns. In this case, the original example with NRebal=+4 actually has the smallest final return of all the strategies shown. The best case, NRebal=−4, posts a 140% return versus the NRebal=+4 of only 10%. This difference is quite substantial. This particular return occurred principally in two years, 2000 and 2009.

The previous example can be extended to identify interesting and potentially profitable signals from historical risk model return portfolios in many ways. For example, one can formally compute the performance of a large number of combinations of risk model return portfolios. For instance:

NRebal (N of rebalance)=−21, −20, −19, −18, . . . −2, −1, 0, 1, 2, . . . 19, 20, 21

NLong (N of Long Portfolio)=NRebal, NRebal−1, NRebal−2, . . .

NShort (N of Short Portfolio)=NRebal, NRebal−1, NRebal−2, . . .

Long Portfolio Risk Model:
Fundamental Factor, Long Horizon,
Statistical Factor, Long Horizon,
Fundamental Factor, Medium Horizon,
Statistical Factor, Medium Horizon,
Fundamental Factor, Short Horizon,
Statistical Factor, Short Horizon, . . .

Short Portfolio Risk Model:
Fundamental Factor, Long Horizon,
Statistical Factor, Long Horizon,
Fundamental Factor, Medium Horizon,
Statistical Factor, Medium Horizon,
Fundamental Factor, Short Horizon,
Statistical Factor, Short Horizon, . . .

Long Portfolio Optimization:
Minimum Risk,
Minimum Tracking Error with 25 Names,
Minimum Tracking Error with 50 Names,
Minimum Tracking Error with 100 Names,
Minimum Risk No Short-Term Momentum (STM) Exposure,
Minimum Tracking Error with 25 Names No STM Exposure,
Minimum Tracking Error with 50 Names No STM Exposure,
Minimum Tracking Error with 100 Names No STM Exposure, . . .

Short Portfolio Optimization:
Minimum Risk,
Minimum Tracking Error with 25 Names,
Minimum Tracking Error with 50 Names,
Minimum Tracking Error with 100 Names,
Minimum Risk No Short-Term Momentum (STM) Exposure,
Minimum Tracking Error with 25 Names No STM Exposure,
Minimum Tracking Error with 50 Names No STM Exposure,
Minimum Tracking Error with 100 Names No STM Exposure, . . .

Note: NShort should not be equal NLong when the other conditions are the same; in that case, the difference of the portfolio returns is identically zero since they represent the same portfolios. NShort and NLong can be equal if different risk models or optimizations are performed.

Many other possibilities will be apparent to those skilled in the art of portfolio construction using optimization tools. For instance, with respect to the optimization problem, one may also want to control or limit the exposure to other risk factors such as medium-term momentum, value, growth or to particular sectors, industries, countries or currencies. The turnover of the portfolio from one date to a second date could also be controlled or limited. The individual asset holdings could be limited by a fixed number or as a fraction of some other quantities, such as the previous twenty day average daily volume (ADV) traded in the market.

By performing performance attribution on the resulting holdings created by taking the long portfolio minus the short portfolio, one can attempt to identify whether the return of risk model return portfolio is correlated or simply related to other important characteristics (e.g., risk model factors, asset classifications, macroeconomic factors). One could then alter the optimization problem to accentuate the desirable characteristics and minimize the undesirable characteristics.

Given the large number of possible choices for NRebal, NLong, NShort, the Long Risk Model, the Short Risk Model, the Long Optimization Problem and the Short Optimization Problem, the number of possible risk model return portfolios is large.

All of the possible combinations considered can be computed and their historical performance calculated. The different combinations can then be ranked utilizing suitable metrics. For example, one could identify the combinations with the best cumulative return over a fixed time window such as the last six months, the last three years, or the last twelve years. Alternatively, one could identify the combinations with the largest Sharpe ratios over a fixed time window such as the last six months, the last three years, or the last twelve years. The Sharpe ratio is the ratio of the annualized realized return divided by the annualized realized risk. One could try various other performance metrics as well.

One could also test various metrics to see if past metric values were good predictors of future performance. This can be done in many ways. For instance, one could regress the previous, twelve months Sharpe Ratios over the last 36 months to see how well they predicted the return of the risk model return portfolio in the month immediately following the twelve months range (the return being taken from NRebal to NRebal). By doing various regressions and computing the statistical significance of the resulting regression coefficients, one can identify good candidate metrics for predicting future performance of the risk model return portfolio. Regressions, and various model fitting procedures are used in the financial modeling world as key tools for making investment decisions. Their use in combination with risk model return portfolios is an important component of the present invention.

Risk model return portfolios represent a rich source of potentially profitable investment opportunities. Because of the large number of parameters that can be varied when specifying a risk model return portfolio, many different signals are available for tracking and understanding market trends. They provide signals that:

Change Intra-Month and Are Reactive. They vary depending on different days of the month, so that intra-month trading patterns can be captured.

Change Smoothly and/or Coherently for Different N=NRebal. This provides confidence that any particular result is not simply a statistically insignificant result, but instead is something that is repeatable. It is important to try to reduce spurious results derived by mining the rich data resources.

Are Repeatable. The patterns appear repeatable over reasonably long periods of time. Different patterns occur during different market conditions, but stability is maintained over reasonable investment horizons.

Because of these valuable characteristics, there are numerous ways in which risk model return portfolios can be used and productized. A list of potential product applications of risk model returns would include the following:

Implied Alphas/Alphas From Risk Models. Risk model return portfolios can be easily translated into implied alphas using the available risk models. Implied alphas are the expected returns that would produce the given holdings in an unconstrained mean-variance optimization portfolio construction problem. Define “a” as the set of implied alphas. Define “w” as the set of asset holdings for any risk model return portfolio as the holdings associated with holding the Long Portfolio long and the Short Portfolio short. This is a long/short dollar neutral set of holdings. If we define the asset-asset covariance matrix defined by any of the available risk models (fundamental/statistical, short/medium horizon, dated for NRebal or any N<NRebal) as Q, then the implied alphas are the matrix product of the Q and w. That is:

a=Qw

The equation given is not uniquely defined for a number of reasons. First, there are many choices for Q. One can also consider averaging various risk models to produce Q. Second, one can choose to include or exclude assets from w and Q that are in the benchmark but have vanishing (zero) holdings. Third, the implied alphas, a, can be scaled by any fixed constant. Any of these choices produce potentially valuable implied alphas, a.

The implied alphas, or, alphas from risk models, are potentially valuable to investors. They are specific to a particular trading day (NRebal). They are specific to a particular universe of investible assets. These implied alphas can be used in conjunction with an existing investment process with minimal additional work. For example, if a portfolio manager already optimizes to create his new set of asset holdings using his own expected return (alpha), he can consider doing precisely the same optimization problem replacing his own alpha with the sum of his own alpha and a small constant times the implied alpha. The purpose of adding the implied alpha is to compensate for intra-month trends that will affect the portfolio manager's performance. By tuning the magnitude and sign of the implied alpha added to the portfolio manager's alpha, one can either compensate for intra-month trends that work against the portfolio manager's process or add additional performance for intra-month trends the work with the portfolio manager's process. This can be done while maintaining all the existing controls on portfolio turnover, transaction costs, portfolio exposures, and the like that already exist within the investment process. The implied alpha used can be whichever implied alpha corresponds to the rebalance time of the existing process.

Alternatively, the portfolio manager can use different implied alphas to determine the best time of the month to rebalance. All of this improves portfolio performance without interrupting the existing investment process.

Time Rebalancing. The risk model return portfolios and their returns and other performance statistics can be used as signals to indicate when during the month is the best time to rebalance a portfolio. Depending on the bets being placed, the intra-month trends can either work for or against the investor. The risk model return portfolios give insight into the time of the month that works best for an investor.

Analyzing Historical Market Trends. The performance of risk model return portfolios can be used to see what kinds of trends have been occurring in the market, particularly the equity markets. As previously stated, many things happen at the end of the month: benchmarks are rebalanced, updated risk models are released (by those vendors who update their risk models on a monthly schedule), portfolio managers produce performance reports and handle cash infusions and disbursements, and companies release financial information. Often portfolio managers rebalance their portfolios soon after the end of the month using updated data and information. These events are one set of circumstances that can help align or define market trends. Other trends include whether market volatility is high or low or changing from a low volatility regime to a high volatility regime or vice versa. The occurrence of a domestic or international recession and other macroeconomic trends such as the global recession that occurred in October 2008 is another set of circumstances. In short, there are a wide variety of circumstances that affect investment opportunities.

Many people believe that markets exhibit trends related to market conditions. For example, some researchers believe that a number of important trends in equity investing are being driven by crowded trading. See, for example, “Speed and Crowding: Converging Dilemmas for Quant Investing”, Nomura International Global Quantitative Research Report, 12 Oct. 2009, by Joseph Mezrich and Yaushi Ishikawa; “Speed and Crowding—Take 2: What a difference a day makes,” Nomura International Global Quantitative Research Report, 2 Nov. 2009, by Joseph Mezrich and Yaushi Ishikawa, both incorporated by reference herein in their entirety.

Risk model return portfolios can be used to (a) corroborate or refute such hypotheses; (b) identify investment opportunities that either align with these hypotheses or are uncorrelated with these hypotheses.

Identifying Best Performing Historical Risk Model Return Portfolios. For many investors, identifying which risk model return portfolios performed the best for either a recent or long term time window may provide sufficient insight in explaining both the market and a particular investor's performance. If, in addition, a performance attribution is done on the associated holdings of these key risk model return portfolios, additional insight can be obtained that may be helpful for investors. For example, factor-based performance attribution may identify risk model factors that have been particularly susceptible to intra-month variations. Returns-based (Brinson-style) attribution may identify sectors or industries with intra-month variations.

Basis for Indexes and ETFs. In recent years, indexes and ETFs (exchange traded funds) have been popular for providing vehicles by which investors can invest in selected market opportunities for relatively low cost. For example, the transaction costs for an individual investor who wishes to invest less than a million dollars in an index such as the Standard and Poors 500 Index or the Russell 2000 Middle and Small Cap Index can be substantial. In addition to simply trading daily to match the time varying constituent weights of these indexes, properly handling dividends (Reinvest in the underlying? Across all holdings? Keep as cash?), the transaction costs associated with individual trades for such a small investment amount would represent a large fraction of the total investment. An investment in an ETF that tracks this index can greatly reduce both the cost and complexity of this investment.

It may be advantageous to create either indexes or ETFs that track those risk model return portfolios with proven track records. That is, for attractive risk model return portfolios, one can create an index or ETF based on the holdings associated with that risk model return portfolio. The holdings associated with the risk model return portfolio may be from a single risk model return portfolio, or the diversified combination of several risk model return portfolios. Such a risk model return portfolio-based index or ETF could be of enormous value to investors.

In addition, a suite of ETFs that had different risk model return portfolios that performed differently during different market conditions would also be attractive. Investors with views on whether market volatility would rise or fall or whether the global economy would surge or stagnate could invest in the associated risk model return portfolio index or ETF that supported the investor's view. This would also allow investors to invest in time-varying views by buying and selling the corresponding Indexes or ETFs.

Return Prediction of Risk Model Return Portfolios. An attractive application of risk model return portfolios is in association with a method for making good predictions of future risk model return portfolios. This could be constructed in a number of ways. One could use single or diversified risk model return portfolios. One could use regression or robust regression; or more involved modeling techniques such as clustering, generalized PCA (see “Estimation of Subspace Arrangements with Applications in Modeling and Segmenting Mixed Data”, by Yi Ma, Allen Y Yan, Harm Derken, and Robert Fossum, SIAM Review, Vol. 50, No 3, pp. 413-458, 2008, incorporated by reference herein in its entirety), the MVT algorithm, Monte Carlo Simulation (see for example, “Monte Carlo Methods in Financial Engineering,” by P. Glasserman, Springer, N.Y., 2000, incorporated by reference herein in its entirety), various statistical modeling techniques, etc. These techniques are particularly well suited to data sets with a large number of dimensions. Historical risk model return portfolio data has a large number of dimensions, so application of these algorithms could be valuable for identifying risk model return portfolios that are likely to have good performance (high return, low risk, or a combination of the two) in the immediate future.

Once good prediction approaches have been identified and tuned, the predictions themselves can be productized in any number of ways similar to those previously discussed. The implied alphas or holdings associated with them could be published and sold. The market trends associated with the risk model return portfolios determined by performance attribution or other data analysis could produce research valuable for marketing and potential sales. At one end of the spectrum, of course, is investing based on such results by creating a hedge fund investing in risk model return portfolios with desirable predicted returns.

While the present invention has been disclosed in the context of various aspects of presently preferred embodiments, it will be recognized that the invention may be suitably applied to other environments consistent with the claims which follow.

I claim:

1. A computer-implemented method for computing and reporting the constituent asset holdings of an asynchronous risk model return portfolio comprising:
storing in a memory a first selection universe of names of possible investment holdings corresponding to a first time;
computing the constituent asset holdings of a first portfolio from the first selection universe by solving a first portfolio construction problem using a first risk model whose risk estimates are associated with the first time;
storing in a memory a second selection universe of names of possible investment holdings corresponding to a second time where the second time is different from the first time;
computing the constituent asset holdings of a second portfolio from the second selection universe by solving a second portfolio construction problem using a second risk model whose risk estimates are associated with the second time;
calculating the constituent asset holdings of the asynchronous risk model return portfolio by analyzing differences in the first and second portfolios;
outputting the constituent asset holdings of the asynchronous risk model return portfolio.

2. The method of claim 1 where the first and second times are different times on the same trading date.

3. The method of claim 1 where the first and second times are different trading dates.

4. The method of claim 1 where the asynchronous risk model return portfolio asset weights are based substantially on a computer based analysis of the difference in weights of the first and second portfolios.

5. The method of claim 1 where the first and second portfolio construction problems minimize or constrain a risk measure computed using the first and second risk models, respectively.

6. The method of claim 1 where the constituent asset holdings of the asynchronous risk model return portfolio are used as a benchmark index.

7. The method of claim 1 where the constituent asset holdings of the asynchronous risk model return portfolio are used for constructing an exchange traded fund or mutual fund.

8. The method of claim 1 where the output further includes the realized return of the asynchronous risk model return portfolio over an historical time period.

9. The method of claim 1 where the output further includes the implied alpha associated with the asynchronous risk model return portfolio and a third risk model, where the third risk model may be either the first or second risk model or a different risk model.

10. A computer-implemented method for computing a quantitative measure of a market trend comprising:
storing in a memory a first selection universe of names of possible investment holdings for the market corresponding to a first time;
computing the constituent asset holdings of a first portfolio from the first selection universe by solving a first portfolio construction problem using a first risk model whose risk estimates are associated with the first time;
storing in a memory a second selection universe of names of possible investment holdings for the market corresponding to a second time where the second time is different than the first time;
computing the constituent asset holdings of a second portfolio from the second selection universe by solving a second portfolio construction problem using a second risk model whose risk estimates are associated with the second time;
evaluating differences in names and weights of the constituent asset holdings of the first and second portfolios to obtain a quantitative measure of a possible trend; and
outputting the quantitative measure of the possible trend.

11. The method of claim 10 wherein said step of evaluating differences further comprises performing backtesting utilizing historical results for the first and second portfolios over a predetermined period of time.

12. The method of claim 11 wherein results of backtesting are automatically evaluated to recognize and highlight sub-periods of time within the predetermined period of time where the quantitative measure of a possible trend exceeds a predetermined amount.

13. The method of claim 10 further comprising utilizing differences in names and weights linked to a quantitative trend in generating an investment portfolio.

14. The method of claim 11 wherein the predetermined period of time includes one or more periods of volatility exceeding a predetermined threshold of high volatility.

15. The method of claim 11 wherein the quantitative measure of a possible trend includes a measure of volatility over one or more periods.

16. A computer-implemented system for computing and reporting the constituent asset holdings of an asynchronous risk model return portfolio comprising:
a memory storing a first selection universe of names of possible investment holdings corresponding to a first time and a second selection universe of names of possible investment holdings corresponding to a second time where the second time is different from the first time;
a programmed processor computing the constituent asset holdings of a first portfolio from the first selection universe by solving a first portfolio construction problem using a first risk model whose risk estimates are associated with the first time, and computing the constituent asset holdings of a second portfolio from the second selection universe by solving a second portfolio construction problem using a second risk model whose risk estimates are associated with the second time;
the programmed processor further calculating the constituent asset holdings of the asynchronous risk model return portfolio by analyzing differences in the first and second portfolios and outputting the constituent asset holdings of the asynchronous risk model return portfolio.

17. The system of claim 16 further comprising a display or a printer for outputting the constituent asset holdings.

18. The system of claim 16 where the first and second times are for different times on the same trading date or for different trading dates.

19. Computer software stored on a storage medium, said software when executed by a computer causing the computer to compute and report the constituent asset holdings of an asynchronous risk model return portfolio by performing the following steps:
storing in a memory a first selection universe of names of possible investment holdings corresponding to a first time;
computing the constituent asset holdings of a first portfolio from the first selection universe by solving a first portfolio construction problem using a first risk model whose risk estimates are associated with the first time;
storing in a memory a second selection universe of names of possible investment holdings corresponding to a second time where the second time is different from the first time;
computing the constituent asset holdings of a second portfolio from the second selection universe by solving a second portfolio construction problem using a second risk model whose risk estimates are associated with the second time;
calculating the constituent asset holdings of the asynchronous risk model return portfolio by analyzing differences in the first and second portfolios;
outputting the constituent asset holdings of the asynchronous risk model return portfolio.

20. The computer software of claim 19 where the first and second times are different times on the same trading date or are different trading dates.
